(19) United States
(12) Patent Application Publication
(10) Pub. No.: US 2022/0129846 A1
(43) Pub. Date: Apr. 28, 2022

(54) Physical Condition Verification System and Method

(71) Applicants: Kristi Montgomery, Chattanooga, TN (US); Trever Ehrlich, Chattanooga, TN (US)

(72) Inventors: Kristi Montgomery, Chattanooga, TN (US); Trever Ehrlich, Chattanooga, TN (US)

(21) Appl. No.: 17/569,178

(22) Filed: Jan. 5, 2022

Related U.S. Application Data
(63) Continuation-in-part of application No. 15/618,334, filed on Jun. 9, 2017.
(60) Provisional application No. 62/348,515, filed on Jun. 10, 2016.

(51) Int. Cl. G06Q 10/08; H04N 1/32

(52) U.S. Cl. CPC G06Q 10/0835; H04N 5/23222; H04N 1/32128

(57) ABSTRACT

A system provides for the linking of searchable information to images, whether they be photographs, virtual reality images, video or other images, with searchable information in data fields whereby upon capturing one or more images, those images can be remotely stored in a database with searchable information. These images can now be located based on key-word searches of the database. For logistics companies, loads can be searched and images at acceptance and delivery points can be viewed to determine where damage may have occurred between a manufacturer and a retailer so that the manufacturer may not necessarily bear the burden of a chargeback when damage occurred after the goods left the manufacturer's facility by sending access to those images to third parties and advising of the status of those goods at a particular location.

### CLAIM OF PRIORITY

This application is a continuation-in-part of U.S. patent application Ser. No. 15/618,334 filed Jun. 9, 2017, which claims the benefit of U.S. Provisional Application No. 62/348,515 filed Jun. 10, 2016, all of which are incorporated by reference herein in its entirety.

### FIELD OF THE INVENTION

The present invention relates to a system and method for uploading images related to the condition of objects through a user interface so that the images can be stored and correlated to the objects for later retrieval such as for identifying the status of goods delivered/received such as from one location to another, identifying a condition of a car before and/or after it goes through a carwash, for home inspections uses, and/or for other uses.

### BACKGROUND OF THE INVENTION

In the transportation and logistics industries, retail charge backs of defective merchandise are a problem for manufacturers and/or distributors. Pallets can be crushed, labels may not be displayed correctly, or other conditions may arise whereby the retailer charges back or refuses goods from the manufacturer or distributor. A distributor and/or manufacturer then must provide a plan for how to deal with this charge-back and/or rejected merchandise.

As it relates to the shipping company and/or the logistics company, which may warehouse the product for a period of time prior to sending on to final disposition, disputes can rise as to who damaged the goods and when.

One method of addressing this issue is to have warehouse employees take pictures of arriving shipments on a digital camera and then manually upload those images to a computer. The problem with this method is that it is not done with a 100% regularity and it relies on the employee to make the upload from the camera to a local computer. Furthermore, the employee is likely to store those images in an image folder which means that the only way to search photos is likely by date as the photos would be identified most likely with a photograph number and date with little if any other identifying information as it relates to the photos taken.

It may be that more sophisticated users might be able to figure out how to label folders related to specific scenarios but even then the only way to access those images would be for the user to know the name of the folder.

Accordingly, a need exists in the transportation and/or logistics areas for a better method of storing images for use for potential later retrieval such as to identify the condition of loads, etc.

A similar need may exist in the home inspection market so as to be able to identify the condition of a home during an inspection.

A similar need may exist to identify the condition of a car before and/or after it proceeds through a carwash.

Additionally, similar needs may exist in other applications and/or industries.

Accordingly, a need exists for new technology.

### SUMMARY OF THE INVENTION

It is a present option of many embodiments of the present invention to provide an improved system and method for having an operator take a series of images related to a particular project such as a load taken off of a truck, a house during a home inspection, a car before and/or after a carwash, or other projects.

Taking the images could be initiated with a button, or other activator, on a camera enabled device which would then allow the user to start taking pictures and/or video such as a mobile wireless communications enabled device (i.e., phones, tablets, etc.). Other devices such as RF handhelds, wearable devices, augmented reality glasses and/or other devices could be used as well. When the project is finished, the user could then press, or otherwise initiate, a finish button and then a window could be provided to the user to identify the project associated with the pictures such as a load number, an order number, a carrier code number, a purchase order, a customer, a tracking number, and/or even allow the user to scan a barcode or other identifier on the load so as to be able then to automatically identify as least some of the data associated with the project. Time, location and/or date may be automatically provided as well. Also, multiple projects could be performed simultaneously, such as by having an ability to switch between projects at one or more various points in the process.

The user may then be able to save the project. The data can be associated with each of the images and/or upload as a file which is then preferably uploaded wirelessly to a remote server to then be hosted by a remote service such as in the cloud, such as an Azure™ database system so as to provide the images to be searchable by potentially any of the information provided with the project.

Accordingly, if a purchase order of a customer is known, the images associated with that purchase order could be rapidly accessed so as to identify when possible damage to the order might have occurred, i.e., whether it was before being received by a particular logistics company such as at the warehouse or otherwise, or whether it was damaged while in the possession of the warehouse company, or after it left the warehouse, etc.

In such a manner the appropriate responsibility for damage could be ascribed to the particular party rather than being borne by the manufacturer and/or distributor as it relates to charge-backs.

Furthermore, for less scrupulous retailers, the final delivery company can utilize this same technology so as to be able to show the condition of the products as it was received on-site by the retailer so that the distribution company and/or manufacturer might dispute charge-backs and prove that the damage occurred while on the premises of the retailer after delivery.

A carwash company may desire to use similar technology to image a car before beginning a wash and/or after finishing a wash process to show that the carwash company did not inflict damage to the vehicle.

Similarly, a home inspector or other real estate professional may desire to image a house as he is performing an inspection so as to be able to show the condition of the house at the time of the inspection as opposed to issues which may develop after the inspection. Security monitoring companies, insurance companies, and/or other companies may benefit from this technology. Other industries, applications, or even individuals, may benefit from the use of similar technology.

Imaging stations could be implemented by various companies such as combining imaging technology with a stretch wrap machine. The imaging equipment, such as a mounted tablet and/or other device, capture images at specific angular positions of the wrapping machine, as it wraps a load, and/or at certain time points as the wrapping machine wraps an article. Other machinery could be equipped with imaging equipment as well to coordinate capture of at least desired images of targets at specific positions and/or times.

Using wearable camera equipped glasses or possibly certain other cameras, a user could take desired images in a hands-free, or at least almost hands-free way, to significantly expedite the image taking process, such as taking images of levels of product as stacked on a pallet, or other process discussed herein. Specific aspects of images could be obtained in at least an almost, if not, hands-free mode with such equipment.

Standard operating procedures could be displayed to a user, such as on a tablet, smart glasses, etc., so that a user may know which images to take of a particular target, such as a load (top, front, back, left, right sides, certain perspective views, etc.). If a specific target is known, an outline or other representation could be outlined on a screen of a device, possibly in combination with the image about to be taken so that a desired size image is obtained. A first, or other, image may be instructed to be made of paperwork such as a packaging slip and/or other paperwork. Some data from the paperwork may be retrieved from that image and/or during the image capture process, such as from a QR code, “reading” or other method. A second, or other image, may be taken of the trailer or other vehicle showing a portion of the target or other specified image. Third and subsequent images may follow a standard operating procedure, or protocol to guide a user through a set of images desired to be captured. Accordingly, at least a standardized set of images may be obtained at specific locations, if not at all locations of the target(s).

Additionally, in the process of imaging the target, particularly when following a SOP (standard operating procedure), completing the imaging step, and uploading the images, may be performed together with an instruction to complete a smart contract so that funds may be released from one party to another, or start a clock (such as the release of funds in 30 or 60 days). The uploading of the images, possibly together with an instruction may confirm the handoff of merchandise or other property from one party to another, such as may be used with a smart contract.

Other industries may benefit from similar technology.

### BRIEF DESCRIPTION OF THE DRAWINGS

The particular features and advantages of the invention as well as other objects will become apparent from the following description taken in connection with the accompanying drawings in which:

FIG. 1 is the front plan view of a camera equipped device using a presently preferred embodiment of the present invention showing a first screen shot;

FIG. 2 shows a front plan view of the device of FIG. 1 with a second screen shot;

FIG. 3 shows a front plan view of the device of FIGS. 1 and 2 with a third screen shot;

FIG. 4 shows a schematic representation including the device of FIGS. 1-3 uploading information through the internet to the cloud such as to a cloud based server which can be accessed by computers;

FIG. 5 shows a perspective view of the device as shown in FIG. 1-4 taking an image of an object in the course of the present preferred embodiment of the present invention;

FIG. 6 shows a perspective view of a similar embodiment as FIG. 5 using camera equipped glasses (as would be worn by a user);

FIG. 7 shows a perspective view of an embodiment similar to FIG. 5;

FIG. 8 shows a diagrammic view of a series of displays showing the imaging of FIGS. 5 and 7 on a screen; and

FIG. 9 shows a perspective view of a wrapping station as may employ a camera equipped device to obtain images in accordance with a standard operating procedure.

### DETAILED DESCRIPTION OF THE PREFERRED EMBODIMENTS

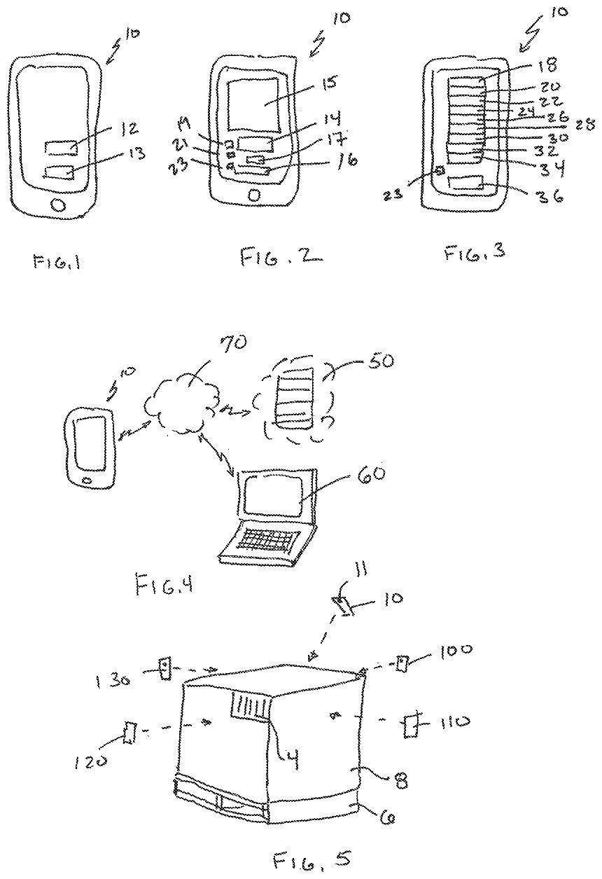

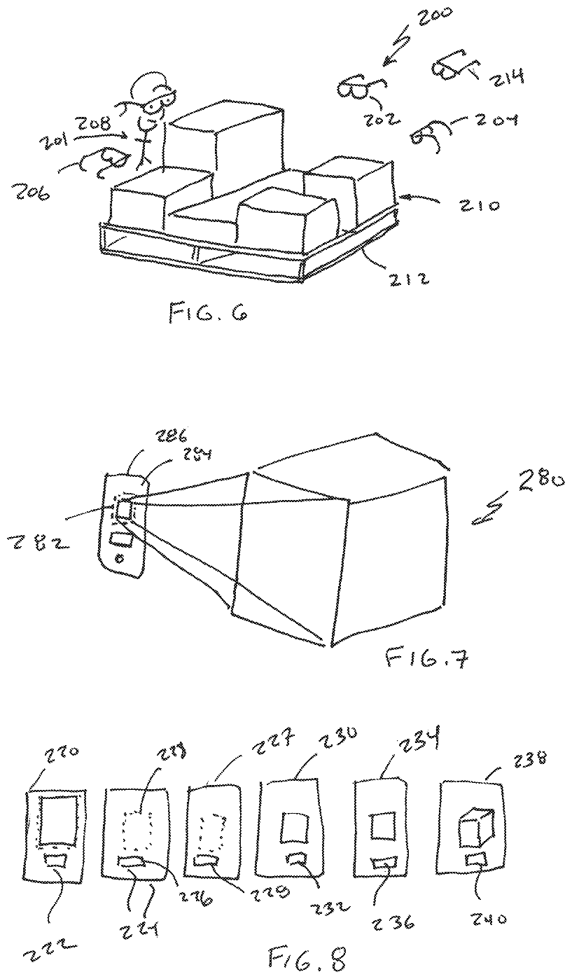

FIG. 1-3 show various screen shots on a camera equipped device 10 such as a smart phone, a tablet computer or other camera enable device, such as a virtual reality device or otherwise having an ability to transmit information, preferably to wirelessly transmit the information, to or through the internet 70, such as to cloud based servers 50 as are shown in FIG. 4 so as to be searchable such as through one of a number of computer(s) 60 preferably through the internet 70 as shown in FIG. 4 and as known by those of ordinary skill in the art and as will be described in further detail below.

FIG. 1 shows a first screen shot of which could be accessed through an app and/or otherwise initiated which could be in the form of a start button 12 or which could be an app icon on a smart phone 10 or tablet or other computer or other device equipped with a camera 11, which could preferably communicate with the internet as would be understood by those of ordinary skill in the art. Some cameras 11 may have such a capability.

After initiating the process in FIG. 1, the process could continue (and/or start) in FIG. 2 with button 14 or other entry mechanism to add or take an image 14 which could then display an area as an image 15 (or not). Specifically, each time button 14 or another button is pressed by an uploader (someone using the camera 11 and/or app), another image could be taken. Some embodiments may superimpose augmented reality such as with Vuzix, Google Glass or other camera enabled device 10 and that additional information may be provided with image 15 and/or data 18-32 as described below.

At this point in time when images are preferably only assigned a time, number, and a date and although they may be put in a pre-established folder, that folder likely does not have any significant data assigned to it relating to the object(s) photographed and may just be assigned a number, a date and a time of the day the image was taken with no further information as added by the user.

When button 16 is pushed, which could be to “end project” or “Finished Adding Images”. Some embodiments may benefit from being able to switch between multiple loads, such as up to or exceeding five or more, batches and/or projects at various points in the process, if not add additional images to an existing folder in storage or on the device 10. Buttons 19, 21 could allow a user to temporarily save, such as on device 10, and/or remotely, partially completed project, and work on a different project and then come back to the initial project to complete. Multiple projects could be worked on in such a way or others. Buttons 19, 21 could provide for “switch to another project”, “lookup a project” and/or provide other switching capability to stop work on a first project to work on a second project.

For example, a user could start load 123456, capture ten pictures for example, get pulled to another order, and stop where you are, possibly assigning a load or batch number and storing them in a temporary holding folder on the device 10 and/or remotely and then start another load, 789456 (for example) and capture twelve photos of it and so on. For many embodiments, when you open a batch and/or finish the photos and click the “finished” or “upload” button, all of the information can be captured, stored and/or added to the remote storage service.

It is preferred for many embodiments that the next screen after “end project” (such as shown in FIG. 3) or similar screen could be provided if not provided earlier, in which information can then be assigned to the pictures 15 when uploaded through a process (whether they be one or more pictures with that particular project as will be explained in further detail below). A setting button 17 could allow a user to adjust settings of various kinds (whether camera related or otherwise) as would be understood by those of ordinary skill in the art.

Specifically, different information may be entered to be associated with the images, such as for a presently preferred embodiment, load information (often a number) at 18, order information (often a number) at 20, SCAC (carrier code) at 22, purchase order information at 24, customer information at 26, task code and/or trailer information at 28, initials of the person taking the pictures at 30 or other identifier of the individual, possibly a biometric entry such as a fingerprint reader (if not provided for elsewhere in the process with the device 10 or otherwise) and/or other information 32, such as GPS data or other data, which could be some other information and there certainly could be more than one other information 32 as provided for various embodiments. Some embodiments may have customizable data or capture fields for information 18-32 (or still other information). Capture fields for information 18-32, etc. may be provided through drop down choices, direct text or other entry mechanism. Certainly not all the various information 18-32 need be provided as provided above for particular embodiments but these data entries have been found helpful for searching characteristics as will be described below for at least one embodiment. Some data may be automatically populated if previously associated with other data (i.e. PO's and load numbers could be tied together (or not), etc.). The identify of an individual at 30 could be auto populated from a fingerprint, biometric device, or associated by particular passwords for different users with the device 10 or otherwise.

A recognize key 23 might be useful either on FIG. 2 or FIG. 3 so that once some information 18-32 is input, it may be possible to auto-populate at least some of the information 18-32 and/or be able to append to existing projects such as described above by switching to other projects, possibly with keys 19,21, or otherwise.

If GPS data is provided as information 32 or otherwise, location stamping may provide a useful tool for various embodiments, such as within a warehouse to identify a particular storage location. Using visual recognition software, such as during an audit of space, software could identify that a specific storage location was empty which could possibly coordinate with Warehouse Management Software to verify the same. Of course, other features or integration with Management Software products could occur as well, such as with Transportation Management Software (TMS), Warehouse Management Software (WMS), Yard Management Software (YMS) so that either the images 15 and/or information 18-32 can be viewed and/or accessed through one or more of the various Management Systems as being fed, and/or data could be pulled from the various Management Systems into information 18-32. Some embodiments envision the system taught herein without ever needing to leave a particular Management System software application to conduct searches for images 15 and/or information 18-32. For at least some of these style embodiments, or others, an end-to-end image enabled supply chain visibility embodiment can be provided from when a shipment leaves a manufacturer to when it arrives at a retail establishment or at the address of a customer. Every step of the way can be documented. One customer has reduced charge backs to date in 2017 95% from the amount of charge backs received over a similar period of time prior to beginning use of the system taught herein.

Using such a system, warehouse location or other audits can be performed, particularly when the images 15 and information 18-32 can be correlated to information in the Management System so as to confirm empty locations, damaged goods or other items of interest. In fact, some embodiments, if a safety issue is photographed, such as an open electrical panel, a checklist or follow up protocol may appear to the user to then follow up, such as to call the building manager and/or put up safety tape, etc. Safety inspections, and Gemba observations may benefit from such embodiments.

Should damaged goods be identified, then images 15 may be collected while following a customers' protocol to provide documentation that the protocol was properly followed and/or while providing the customer the ability to override, or make decisions regarding course of action to follow for disposal of damaged goods, i.e., whether to repack, scrap, etc.

Images 15 are referred to as camera images, but could also be video, .pdf images of documents or other images as would be understood in the art, such as proof of signature images or data, etc. Images 15 may be taken by camera equipped devices 10 through the pushing of buttons, voice enabled image capture, automatically, and/or with input from other systems and/or equipment. Uploading of images 15 may be accomplished in a similar or dissimilar manner. Hands free may be attractive for at least some embodiments. Some camera equipped devices 10 may be mounted to various structures, such as fork lifts, and the camera equipped device 10 could be thought of as the fork lift, possibly in cooperation with an onboard computer which may have other uses, such as part of the Warehouse Management System or other use. Such camera equipped devices 10 might be automatically and/or manually controlled by various computers and/or users.

For at least some embodiments, the images 15 are uploaded to remote server 50 where they may be searched based on the information 18-32, etc. by an authorized user. Hierarchy assignment of access is likely to occur with many embodiments. Specifically, at a corporate level, one might have access to all images 15 and information 18-32 associated with a particular company, but not likely access to such data related to other companies. Such access may not have the ability to modify any information 18-32 or change images. A network administrator might have similar or different access, such as an ability to prescribe at least some of the information obtained 18-32 and possibly have access to make some changes. At a site level, additional information 18-32 might be prescribed, but it is likely that one site might not be able to access at least some information from other sites (such as images or information not related to any event at the site). Users that upload images 15 might not have access to the images 15 of others and/or at other sites, or otherwise be further limited. Other hierarchal based controls may be provided with various embodiments. Users might also be able to add fields of data 18-32 in addition to those prescribed by the site or the company. Some fields 18-32 might be required, others might be optional for various embodiments.

At button 34 or other entry mechanism may provide access to a reader in which a barcode, Q-code or other code could be scanned and at least some information, automatically or otherwise, uploaded into at least some if not all of the various categories as described in relationship to FIG. 3 or to others assigned to the photograph(s) 15. Other readers could be used as will such as optical recognition, etc. For instance, a storage algorithm in the cloud, at the computer equipped device 10, or otherwise could analyze each batch to determine if any of the images contain readable text such as a packing list or bill of lading and could automatically apply optical character recognition to at least portions of the upload so text in the document could be searchable as well as the other data entered at time of upload. Some of the text might be input as information 18-32 as well.

Visual comparisons could be provided with various embodiments to identify if the image captured 15 is what was expected. For instance, seal tampering might be identified by comparing image 15 to an expected image. Similarly, an alert may be issued if an imaged labeling issue is not within specified ranges, if optical character recognition identifies data which is inconsistent with information 18-32 (such as the incorrect load number, etc.). Positioning within a warehouse could also be audited such as warehouse zones, location numbers, etc., such as with GPS data and/or visual recognition software so as to populate at least some information 18-32 attached to images 15 and/or possibly coordinate with Management Software for various capabilities as described herein or otherwise.

It is further anticipated that the time, date, and location of the photograph 15 could be automatically uploaded if not already provided as any of information 18-32. The button 36 could then be pushed to save the project. The screen shot(s) of FIG. 1 and/or FIG. 2 could then be presented back to the user or begin working on another project if and when the user is ready to begin again.

Upon pushing button 36 the process shown in FIG. 4 can initiate, if not already initiated, where the images could be uploaded preferably wirelessly such as through the internet 70 to a cloud based and/or remote server 50. A cloud based server is illustrated as a remote server 50 although a physical server stack could be utilized with other embodiments as would be understood by those ordinarily skilled in the art. Remote server 50 could be an Azure™ based database system or other database system as would be understood by those or ordinary skill in the art. With all the photographs and/or images 15 grouped and having associated data such as provided from 18-32 or otherwise from FIG. 3 possibly along with at least some of time, date and location which could be entered or changed with button 13 of FIG. 1 or otherwise, an operator accessing using computer 60 with proper access can then relatively easily locate images 15 of an object based on information related to any of the data 18-32 or other information associated with the images 15 to then be able to access those particular images 15. Notes related to damage and/or other information could be provided here and/or elsewhere. Changing locations could occur by pushing icon 13 or other icon as could be provided on FIG. 2 or 3. Location could be by way of example a warehouse receiving at 1103 Market Street, Chattanooga, Tenn. and/or could be by common language “receiving,” etc. and/or physical address. An upload could not only capture the user ID, time and date for some embodiments, but also a quantity of photos uploaded, and store that information attached to each photo and/or the storage bin (folder) assigned.

For instance, in order to search a particular load received at a warehouse, if the load number is known or load identification is known, then it could be searched by the operator 60 and those images of the load when the load was received at that warehouse could potentially then be accessed to know whether or not the load was damaged upon or before arrival at the warehouse. Further narrowing of a search may be helpful if an object provided through multiple imaging stops such as by different (or the same) logistics companies and/or uploaded to a common remote server 50 or host. Searches may include keyword searches, date range searches, and/or field specific searches. It may also be that the load is photographed once again as it is loaded onto a delivery truck. Various sets of images could be compared to see whether or not damage occurred at the warehouse or other location. Some operators 60 have only read only access (unable to alter data). Customers might only be able to only access information/related images to their goods for some embodiments.

FIG. 5 is useful because it shows the camera enabled device 10 taking images from a variety of positions relative to a pallet of goods 8, illustrating a stack of goods 8 located on a pallet 6, also known as palletized goods, as could occur in at least one embodiment. Furthermore, a barcode 4 or other label is shown which could be imaged as well, such as during the process described in reference to FIG. 3 above, to at least automatically upload some of the data provided on the screen shot.

Additionally, the locations of labeling can be important in the images as one of the five photographs of the load or good(s) also referred to as target 8 which could show the barcode 4 (or other labeling 4) as it is displayed to see whether or not it is on the correct position which might or might not be objectionable to at least some future parties downstream in the chain of commerce such as retailers and big box stores and/or others.

Although the illustrated embodiment relates to the photographing of loads such as taken off a truck and the logistic process of transportation, storage, possibly in warehouses or otherwise, and ultimate distribution to customer such as a retailer, other uses such as taking pictures of a car at a car wash either before and/or after the wash process, may be provided using similar technology. For instance, more than one camera, such as the five cameras 10 illustrated in FIG. 5, some of which (if not all) could be permanently mounted such as at the front of a carwash so as to take a picture of the various front, back, left, right and/or top of a target 8, such as the vehicle, possibly with a way to capture the tag number to then automatically assign the tag number to images of that car as it proceeds through the carwash so as to be associated at least with the tag number of the vehicle so as to be searchable if necessary so as to provide proof that the condition of the car as it entered and/or exited the carwash to show it was in the same condition as it was when it arrived if necessary by the operator of the carwash.

Additionally, home inspectors could take images with camera device 10 as they proceed through a home to show the condition of the target 8 or home as it was when they made the condition report. If something were to happen to the home after the condition report, they could show that that was not the state of the home as they were conducting their inspection. For instance, if a tree fell on the house after the home inspector left the house, it would likely be readily apparent that the tree had not fallen on the house during the home inspection and certainly is anticipated that it is likely that more than five pictures would be taken in such a scenario.

Of course, more than five pictures or series of images 15 could be taken within a particular load as there could be multiple pallets 6 and/or multiple products all of which might benefit from having a picture taken from at least each side and which could include potentially at least all sides or as many sides as possible such as the five sides shown in FIG. 5 and even some embodiments may have a way to photograph the bottom.

Furthermore, automatic systems such as could be employed in various embodiments such as at carwashes or other locations possibly with multiple cameras linked together possibly along with a processor coordinating at least some of the image taking process.

Furthermore, in the logistics industry it may be that at warehouses where a forklift removes product from a truck, the goods or target 8 could be photographed by multiple cameras such as shown in FIG. 5 and/or sequentially but with automatic photographing or other imaging such as could occur possibly with the information being associated with those photographs 15 being provided such as in FIG. 3 possibly by taking pictures of barcodes 4 and other labeling provided in FIG. 4 which could be standardized by particular companies with their particular use of the embodiment as described herein so as to automate the process as much as possible.

In one embodiment of a presently preferred embodiment of the present invention, a method provides a data storage and retrieval system for computer memory comprising means for configuring said memory according to a logical database correlation whereby at least one if not a plurality of pictures are taken by one or more camera equipped device such as a cell phone, a smart phone, a tablet, computer, or other camera equipped device, preferably having at least one device (camera equipped or otherwise in communication with the camera equipped device(s) 10) connectivity (preferably wireless for at least some embodiments) with a remote server 50 such as a physical server or a cloud based server such as through the internet or otherwise.

Although an initial system with only a first device 10 is contemplated, there could easily be a plurality of devices 10 utilized possibly at least a somewhat automated manner so at least one if not a plurality of pictures is taken of an object or series of objects until the project is completed, such as by pressing a stop button or otherwise which then allows for the assignment of information to that series of pictures. Specifically, for the logistics industry, such information could include load identifier, order identification, carrier code, purchase order, customer, or other information related to an object can be uploaded either manually by user and/or utilizing a barcode reader and a barcode activator until at least some if not a plurality of information, possibly in addition to time and date as well as location and/or operator, can then be saved along with the one or more pictures taken to the server 50 so that a computer 60 can then be search the database by the data provided with the pictures such as by load, identifier, carrier code identifier, purchase order identifier, customer identifier, such as customer name and/or other data all of which could have been manually or automatically input into the database with the pictures.

This is particularly helpful in at least some embodiments so that particularly the logistics industry where the condition of the imaged products such as goods 8 on pallet 6 could have the photographs of the objects pulled up at the computer 60 for review so as to determine the condition of the object at the time of being imaged with one or more devices 10. Relevant images/information can then be output or sent via email to otherwise as would be understood by those of ordinary skill in the art.

For some embodiments this would be the time that the load was received at a warehouse or by a customer. It could be taken by any number of parties whether it be the transportation company to prove that the goods were in the same shape as when the transportation company received it and the logistics company to prove that the goods received at a warehouse were in the same condition when they left the warehouse, etc.

There are a number of different ways that the database could be configured within the computer such as by assigning each of the pictures 15 all or some of the data 18-32 possibly in addition to at least some of the time, date and/or location, and/or other data. Alternatively, a folder could be created having at least some of the data 18-34 together with possibly at least some of a time, date and/or location as a folder identifier which then houses the pictures 15 therein. Still other methods of assigning at least some of the data 18-34 possibly together with time, date and/or location could be provided as would be understood by those of ordinary skill in the art.

In many preferred embodiments, the data and the database 50 could then be searched so as to identify the condition of various goods or target(s) 8.

Of course, for other applications as immediately come to mind such as carwashes or home inspection, real estate, security monitoring, insurance companies, etc., the process can be performed such as described herein and/or otherwise. Still other industries and even individuals may benefit from similar applications. For instance, the real estate industry might be able to benefit by capturing images of rental or leased property or have still other applications. Transportation including the logistics industry described herein as well as other transportation industries such as trucking, rail, ocean and/or air may benefit such as by capturing before and/or after images of cargo. Insurance agencies might benefit by possibly by taking initial coverage images and/or claim images. The safety or insurance industry may benefit by providing images internal to manufacturing, warehouse or other environments such as when conducting a safety audit and/or after a safety incident, inspection, or claim. Field technicians or other parties such as cable, satellite, electricians, plumbers may be able to document before and after conditions for their customers and/or other parties such as inspectors which may certainly use the technology and/or benefit therefrom. The information technology industry may benefit by providing data sooner or infrastructure documentation. Additionally, the remote repair industry such as even auto body shops or others might be able to benefit by capturing photographs of items needing repair so that parts could be ordered before the repair process is scheduled to begin. Individuals might be able to assign data to images 15 so as to be able to relatively quickly identify images 15, such as the vacation on which the images were taken, or who (or what) is in the images 15, etc. Still other industries and/or applications are believed to benefit from this technology as well.

Additionally, although the interfaces are rudimentary as shown on the screen shots of FIG. 1-3, the sophistication of the screen shots could be changed according to the various embodiments as desired by the users. Furthermore, various corporate entities will likely be interested in having the technology described although many within the various chain such as the manufacturer to show the condition of goods as they are shipped from manufacturer's location, the trucking company taking the goods from the manufacturer to a logistics company warehouse as they unload and offloaded form a truck, the warehouse logistics company as the goods are off loaded from the trucks and then provided to be loaded to another truck and yet the final delivery company as the goods are taken from the warehouse and delivered to the retailer as well as possibly the retailer to show the condition of the goods as received by a trucking company. Accordingly, to the extent any particular load is damaged, the party responsible for the damage could be more readily identified than prior art methods by being able to search one or more databases 50 so as to identify where in the chain the goods may have been damaged.

By having such a system, it is likely that the manufacturers are not as likely to experience the relatively significant charge-back cost which may range in the millions of dollars for various retailers that they currently experience so that they may then be able to have other parties share in this current loss that they are experiencing due to the damage of the goods by parties other than the manufacturer, if they so desire.

What is believed to distinguish this method and system described herein from prior art systems is the ability to automatically associate data for search purposes together with images as those images are uploaded to a server rather than first creating a folder and then depositing pictures in that folder for the folder to be searched.

While for some embodiments it may be possible to assign all data to a folder having the pictures stored in that folder. For many embodiments it is envisioned that the data is to be assigned to each of the pictures as they are uploaded to the database. This is different than putting pictures in a folder and then sharing that folder with servers or with the folder created and data provided on the folder with the pictures then put in the folder.

Specifically, for many embodiments information is attached, preferably automatically, to the pictures and/or to the folder after taking the pictures.

FIG. 6 shows another embodiment of the present preferred invention utilizing an essentially hands-free camera in the form of glasses 200 which would be worn by a user 201 in the various positions (and/or others) of the glasses 200 as would be understood from the figure. Positions 202, 204, 206, 208, and 214 of the glasses 200 (and/or others) relative to a target 210 which could be a partial or fully loaded pallet 212. Imaging could occur such as by touching a button on the glasses 200, or the glasses 200 could follow a standard operating procedure to take images at specific locations when looking at a target 210, depending upon the sophistication of the software employed. The taking of images could be hands free, or substantially hands free, depending on how the camera equipped device 200 follows the standard operating procedure to take the images.

FIG. 6 may show the first level of loading of a pallet 212 with load 210, then subsequent layers could be added and images taken with the positions 202, 204, 206, 208, and also 214. Positions 202, 204, 206, 208, may be plan views and position 214 may be more of a perspective view so as to substantially at least partially show the top. Other views could be taken with other embodiments.

As shown, FIG. 8, it may be that a packing list 220 is first imaged and then possibly some of that data utilized to coordinate with that image as well as with other images such as could be obtained through machinery or software QR code recognition or other recognition software so as to auto-populate certain portions updated to be associated with the images as is discussed above. Instructions 222 may provide a part of a standard operating procedure to the user so as to take an image of the packaging slip. At 224, a front side may be instructed with instructions 226 to be put within a representation such a shaded area, an outline 228, etc. for a front image of the target 210 or target 280 as shown in FIG. 7 with the target 280 being placed at a desired location 282 such as an indicated location on a display 284 of a camera equipable device 286 which could be a tablet, cell phone, computer equipped glasses that are computer and camera coordinated glasses 200, etc. A standard operating procedure may continue, such as after capturing the image shown in FIG. 8 at 224 to instruct the image to be taken at 226 with instructions 228 of another side and then at 230, instructions 232 may provide for yet another side and at 234 yet instructions 236 may provide for imaging of yet another side, possibly at 238 instructions 240 for a perspective view or otherwise to be taken. Accordingly, by providing a standard operating procedure, possibly with displayed instructions such as a 222, 226, 228, 232, 236, 240, etc. specific images could be instructed to be taken by the device 286, 200, etc.

By imaging symbols or wording such as at instructions 222, fields may be auto-populated to be associated with the images when uploaded. Still other of the data associated with the images such as the name of the user, the gender, and his or her age, may be coordinated as well based on that user logging into the application and/or device. The instructions 222, 226, 228, 232, 236, 240 can utilize to guide a user through taking photographs of a specific target 280, 210, etc. possibly at different locations, times and/or conditions preferably in accordance with a standard operating procedure. When the standard operating procedure is followed at different locations for similar imaging, similar images may be readily easily compared to others to identify specific issues such as (a) damage, (b) lack of damage, and/or (c) labeling (which either complies or fails to comply with directives). It may be possible that the standard operating procedure requires images of certain views, but allows a user to take additional images above and beyond the standard operating procedure.

Additionally, by providing a somewhat standard set of images or at least taking some images, smart contracts can be performed (or conditions therewithin performed) such as by triggering the start of a thirty (30) day payment term, indicating a transfer of responsibility of a particular target 210, 280, etc. from one party to another such as from a trucking company to a warehouse, from a trans-pacific shipping company to an unloading facility to a trucking company, etc. By knowing who or where the images are taken, it may then confirm that a transfer of ownership or responsibility has occurred or the specific location therefor to potentially complete a step in the logistics chain. Block chain systems may also be employed so that when a set of images are uploaded at a specific location, a new owner may be known to take ownership of the goods. A notice may be sent with the taking of the images advising of completion of a step in a smart contract to thereby be completion of a condition for another step to occur (such as to start a time period to release funds, to release funds, and/or to transfer responsibility for the target 280, 210, etc.). The images could be accessible to and/or provided with the notice sent to the third party, which may be manually or automatedly performed,

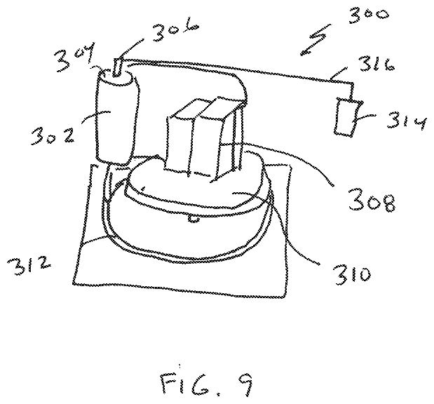

FIG. 9 shows a stretch wrap application device 300 having a supply of wrapping material 302 such as on a roll 304 supported by an arm 306. The material 302 may be directed relatively about a load 308 whereby the load 308 may rotate such as on a turntable 310 relative to the material 302 to the roll 304 and/or the roll 304 may be directed about the load 308 such as on a track 312 so as to circumnavigate a stationary load 308 as would be known in the art. Meanwhile, a camera-equipped device 314 may be provided as a portion of the loading station 300 such as connected by boom 316 connected to arm 306 supporting the roll 304 or otherwise. The camera equipped device 314 may be electronically connected rather than physically connected for still other embodiments.

Images may be taken by the camera-equipped 314 either at specific positions of the camera-equipped device 314 relative to load 308, at specific times such as time of operation of the wrapping process and/or under other conditions so as to attain at least a minimal set of images of load 308 (likely following a standard operating procedure) before, after, and/or during the wrapping process, if not a standardized set of images for the wrapping process so as to verify proper wrapping of the load 308 and condition of the load in the future.

Other equipment including but not limited to loading chutes, weight scales, packing machines and other machines may be camera equipped in a similar fashion or differently than the wrapping machine 300 so that parties may be able to verify the condition of products during the logistics process of packaging and/or moving targets from one location to another to attempt to verify or identify the party responsibility for damage or condition during various stages of the logistics process. These images may be sent, or at least provided access to, along with notification to a third party advising of the location of a specific issue.

Accordingly, when a user searches a database, an issue is found, the user can identify the particular issue whether it be a labeling issue, a damage issue, a confirmation that there was no damage at a specific location, etc., and provide proof either through a link to specific images and/or provide those images along with data showing that a specific condition was present at a specific location along the life of the target, etc.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A method for attaching information to groups of images for condition verification comprising the steps of:
(a) creating a standard operating procedure requiring a set of specific images selected from the group of photos, augmented reality photos, and video to be taken of a target selected from a group of a load being shipped, a load in storage and a received load;
(b) capturing the set of images as a first set at a first location with at least one camera equipped device of the target in accordance with the standard operating procedure by a first party;
(c) linking searchable information related to the target independently of image metadata obtained in the image capture step in at least one data field to the at least one image captured at the first location separately from the image capture step in a data capture step and having at least a load identifier associated with the target;
(d) uploading the first set captured at the first location with the searchable information related to the load wirelessly from the portable camera equipped device to remote storage in a database;
(e) moving the target by vehicle from the first location to a second location;
(f) capturing the set of images as a second set at a second location by a second party with at least one camera equipped device through an app of the target, using the standard operating procedure, said second location geographically spaced from the first location, said second party different from the first party;
(g) linking searchable information related to the target in at least one data field directly to each of the second set captured at the second location separately from the image capture step independently of image metadata obtained in the image capture step in a data capture step and having at least the load identifier associated with the target;
(h) uploading the second set captured at the second location with the searchable information wirelessly from the camera equipped device to the remote storage in the database; wherein if searching the database with the load identifier, the first and the second set are viewable to a second user searching remotely from the first and second location with the second user sending notification to a third party related to a condition of the target at one of the first and second location and mis-labeled, with viewing access to the third party provided to at least one of the first and second set.

2. The method of claim 1 wherein the notification of the condition of the target is one of received, damaged, not damaged, correctly labeled, and mis-labeled.

3. The method of claim 1 wherein at least one data field is auto-populated with at least some searchable information obtained through optical recognition from a first image of the first set to which it is linked directly.

4. The method of claim 3 wherein a smart contract is fulfilled upon receipt of the notification.

5. The method of claim 1 wherein a smart contract is fulfilled upon receipt of notification to by the third party.

6. The method of claim 1 wherein the at least one data field is auto-populated with at least some searchable information obtained from a code reader interpreting a first image of the first set to which it is linked directly.

7. The method of claim 1 wherein the search is executed within a Management System by the second user.

8. The method of claim 1 wherein instructions are displayed on the camera equipped device related to the standard operating procedure directing the taking of specific images for the first and second set.

9. The method of claim 1 wherein the camera equipped device is one of a smartphone, camera equipped glasses, and a tablet and the information and the images related to load are correlated through the database as taken from multiple physical locations taken by multiple users through the app.

10. The method of claim 1 wherein the second user remotely searches the database with a computer to identify if any images exist related to input information related to the load in the search from either the first or second location, and if a match is found between input information and searchable information, identifying the images with their respective first or second location and displaying selected images to the second user for viewing; said second user examining the displayed images for an issue of at least one of damage, lack of damage, and labeling to the target present at the first location and identifying if the at least one of damage and labeling to the target was present at the first location based on at least one image captured by the first user thereby ascertaining if the issue occurred before or after the first user captured the at least one image at the first location; said second user positively identifying the issue as having occurred at or before one of the first and second location and providing an output providing access to at least some of images from at least one of the first and second location to a third party while notifying the third party of the issue for the third party to verify the condition of the load at the at least one of the first and second location.

11. The method of claim 10 wherein the input information is searched by the data field.

12. The method of claim 11 further comprising at least two data fields and wherein at least a second data field is auto-populated based on data in a first data field.

13. The method of claim 11 wherein a first data field is auto-populated with searchable information.

14. The method of claim 13 wherein the first data field is auto-populated with site location information based on GPS data.

15. The method of claim 1 wherein at least two images are simultaneously directly assigned searchable information to separate data fields.

16. The method of claim 1 wherein the at least data field is set by one of a hierarchy participant.

17. The method of claim 1 wherein a hierarchy participant selected from a company representative, a site representative and the first user have different access to the database.

18. The method of claim 1 wherein the at least one image is associated with a first project and interrupting the first project with entering a second project having at least one image through the step of uploading to the database, and then resuming the first project while maintaining the at least one image and information related to the first project entered prior to interruption.
